(19) United States
(12) Patent Application Publication
(10) Pub. No.: US 2022/0089354 A1
(43) Pub. Date: Mar. 24, 2022

(54) AERIAL DELIVERY PACKAGES

(71) Applicant: DGP INTELSIUS LIMITED, York (GB)

(72) Inventors: Jens MANGELSEN, York (GB); Richard MERCHANT, York (GB)

(21) Appl. No.: 17/426,256

(22) PCT Filed: Jan. 28, 2020
(86) PCT No.: PCT/GB2020/050199

§ 371 Date: Jul. 28, 2021

(30) Foreign Application Priority Data
Jan. 28, 2019 (GB) 1901163.4

(51) Int. Cl. B65D 81/38; B64C 39/02; B64D 1/12; B65D 65/46; B65D 5/00; B65D 5/02; B65D 5/32

(52) U.S. Cl. CPC B65D 81/3848; B64C 39/024; B64D 1/12; B65D 65/466; B64C 2201/128; B65D 5/029; B65D 5/32; B65D 5/0254; B65D 5/008

(57) ABSTRACT

A thermally insulated package 100 for transporting a temperature sensitive payload by unmanned aerial vehicle. The thermally insulated package comprises a payload retention volume 150, at least one layer of insulation 121, 122 surrounding the payload retention volume 150 and an outer casing 110 enclosing the at least one layer of insulation 121, 122 and the payload retention volume 150. The thermally insulated package 100 is shaped to reduce drag in flight by having an aerodynamic shape, particularly in a nose section 130 and optionally a tail section 140. The thermally insulated package 100 may be particularly suitable as a single use packaging for transporting temperature sensitive goods to remote locations. A packaging blank 200 and an unmanned aerial vehicle comprising the thermally insulated package 100 are also disclosed.

### FIELD

The present invention relates to a thermally insulated package for transporting a temperature sensitive payload by unmanned aerial vehicle, to an unmanned aerial vehicle comprising such a package and to a packaging blank for forming such a package. In some embodiments, the invention relates to a single use biodegradable thermally insulated package for transportation by unmanned aerial vehicle.

### BACKGROUND

The transportation of temperature sensitive goods requires the use of packaging which can maintain the temperature of the temperature sensitive goods within a pre-determined range. This may be achieved by providing a packaging item with insulation, either in the form of loose insulation material or by constructing a rigid box out of an insulating material. For example, rigid insulating boxes made from polystyrene foam have been used for many years to transport various temperature sensitive goods such as medical supplies and biological samples.

Temperature sensitive goods, such as biological material, may be of high value in terms of cost and also in terms of the importance of the goods to the recipients, for example medical practitioners or researchers. In many cases, the temperature sensitive goods will only be accepted for their intended purpose if their temperature has been maintained within a specified range during transportation, for example to ensure the quality and safety of the temperature sensitive goods. Therefore it advantageous to monitor the internal temperature of such thermally insulated packages during transportation.

Unmanned aerial vehicles (UAVs), otherwise known as drones, have been adapted to deliver packages, but no convenient and cost effective packaging solution for the transportation of temperature sensitive goods has been provided to date.

### SUMMARY OF THE INVENTION

It is one aim of the present invention, amongst others, to provide a thermally insulated package that addresses at least one disadvantage of the prior art, whether identified here or elsewhere, or to provide an alternative to existing thermally insulated packages. For instance it may be an aim of the present invention to provide a thermally insulated package which facilitates transportation of a temperature sensitive payload by unmanned aerial vehicle.

According to aspects of the present invention, there is provided a thermally insulated package, an unmanned aerial vehicle and a packaging blank as set forth in the appended claims. Other features of the invention will be apparent from the dependent claims, and the description which follows.

According to a first aspect of the present invention, there is provided a thermally insulated package for transportation by unmanned aerial vehicle, the thermally insulated package comprising:

a payload retention volume;

at least one layer of insulation surrounding the payload retention volume;

an outer casing enclosing the at least one layer of insulation and the payload retention volume; and

an aerodynamic nose section arranged at the front of the thermally insulated package with respect to the direction of flight of said unmanned aerial vehicle.

The term thermally insulated package would be understood by the person skilled in the art as referring to a package incorporating known insulating materials with the deliberate intention of retarding the rate at which a cooled payload inside the package heats up due to the ingress of thermal energy from outside the package. Similarly, said thermally insulated package may be used to retard the rate at which a controlled room temperature payload inside the package cools down due to the outflow of thermal energy from inside the package.

Packages not comprising a significant amount of insulating material and which do not significantly retard the rate at which a cooled payload inside the package heats up (or a controlled room temperature payload inside the package cools down) would not be considered “thermally insulated packages”.

The thermally insulated package comprises a payload retention volume. This payload retention volume is suitably formed from/defined by the at least one layer of insulation, for example insulating panels and/or coolant or phase-change material containing vessels. Suitably the payload retention chamber is where temperature sensitive goods would be transported in said thermally insulated package. The payload retention volume is suitably a cooled and insulated payload retention volume in use, due to the pre-cooling of at least some parts of the thermally insulated package and the insulating properties of the at least one layer of insulation. The payload retention volume is suitably substantially cubic or cuboid in shape.

The at least one layer of insulation surrounds the payload retention volume and suitably comprises insulating material and/or coolant or phase-change material containing vessels. Suitably the insulation layer comprises panels of insulating material and/or coolant or phase-change material containing vessels. Suitably the insulation layer comprises panels of insulating material and coolant or phase-change material containing vessels. Suitably the at least one layer of insulation defines the payload retention volume and substantially defines the outer shape of the thermally insulated package.

The outer casing encloses the at least one layer of insulation and the payload retention volume. The outer casing suitably provides structural support to the arrangement of the at least one layer of insulation within the thermally insulated package and suitably protects the at least one layer of insulation and any goods in the payload retention volume from physical contact from outside the package and may protect the package from the ingress of water and/or ambient air. The outer casing may be constructed from a polymeric material or cardboard, for example.

The thermally insulated package comprises an aerodynamic nose section arranged at the front of the thermally insulated package with respect to the direction of flight of said unmanned aerial vehicle. The nose section being at the front of the package means that it is the nose section which experiences the most air resistance during normal flight of said unmanned aerial vehicle, for example forward flight of said unmanned aerial vehicle. Therefore, due to the shape of the nose section, the air resistance (or drag) experienced by the package is reduced, suitably compared to known packages which are transported by unmanned aerial vehicle which have a typical cubic or cuboid shape. Such known cubic or cuboid packages present a front face of the package which is perpendicular to the direction of flight of said unmanned aerial vehicle and therefore experiences high air resistance. The reduction in air resistance provided by the aerodynamic nose section may have the effect of reducing the amount of energy said unmanned aerial vehicle needs to expend to transport the package a certain distance. This may increase the useful range of such a delivery method and/or improve the cost effectiveness and environmental profile of such a delivery method. This is particularly significant when said delivery is to take place in a remote area where long distances will need to be covered to deliver said temperature sensitive goods to their intended destination.

To provide a suitable aerodynamic shape, the nose section suitably tapers to a leading end. The leading end is suitably the front most part of the package which, when moving in a forward direction deflects or directs air over and/or under and/or to the sides of the package, thereby reducing drag.

In some embodiments, the nose section may have a cone shape, therefore the leading end may be a leading point (or tip) of the cone.

In some embodiments, the leading end of the nose section is a leading edge at the front of the nose section. Suitably the leading edge is formed by the meeting of at least two planar faces of the nose section, suitably at least four faces.

The thermally insulated package suitably comprises a main body section which houses the payload retention volume and the at least one layer of insulation, wherein the main body section has an approximately cubic or cuboid shape. Suitably the main body section is connected to the nose section.

Suitably the nose section tapers from the main body section to a leading end of the nose section. Suitably at least one face of the nose section (suitably a planar face) tapers from the main body section to the leading edge.

Suitably the nose section comprises a top face, a bottom face and two side faces which meet at the leading edge and are arranged at acute angles to the direction of flight of said unmanned aerial vehicle.

Suitably at least one of the faces of the nose section provides an access door to the payload retention volume.

In some embodiments, the nose section comprises more than four faces, suitably tapering to a leading end. For example the nose section may comprise from four to twenty four faces, each arranged at acute angles to the direction of flight of said unmanned aerial vehicle and suitably tapering from the main body section to the leading tip or edge.

Suitably the thermally insulated package comprises an aerodynamic tail section arranged at the rear of the thermally insulated package with respect to the direction of flight of said unmanned aerial vehicle. Suitably the aerodynamic tail section provides a further reduction in air resistance compared to known cubic or cuboid packages which comprise a rear face of the package which is perpendicular to the direction of flight of said unmanned aerial vehicle.

To provide a suitable aerodynamic shape, the tail section suitably tapers to a trailing end.

In some embodiments, the tail section may have a cone shape, therefore the trailing end may be a trailing point (or tip) of the cone.

In some embodiments, the trailing end of the tail section is a trailing edge at the rear of the tail section. Suitably the trailing edge is formed by the meeting of at least two planar faces of the tail section.

Suitably the tail section tapers from a main body section of the thermally insulated package to a trailing end of the tail section. Suitably at least one face of the tail section (suitably a planar face) tapers from the main body section to the trailing edge.

Suitably the tail section comprises a top face, a bottom face and two side faces which meet at the trailing edge and are arranged at acute angles to the direction of flight of said unmanned aerial vehicle.

In some embodiments, the tail section comprises more than four faces, suitably tapering to a trailing end. For example the tail section may comprise from four to twenty four faces, each arranged at acute angles to the direction of flight of said unmanned aerial vehicle and suitably tapering from the main body section to the trailing tip or edge.

The tail section may comprise a tail storage volume, suitably for storing a non-temperature controlled payload, for example a device, an accessory or a document. Suitably at least one of the faces of the tail section provides an access door to the payload retention volume and/or to a tail storage volume.

In some embodiments, the main body of the thermally insulated package of this first aspect may have an aerodynamic shape. The main body may have an aerodynamic shape which is a continuation of the shape of the aerodynamic nose section. For example, the main body may taper to the nose section, which may taper to a leading end.

In embodiments wherein the thermally insulated package comprises an aerodynamic tail section, the main body may have an aerodynamic shape which is a continuation of the the shape of the aerodynamic tail section. For example, the main body may taper to the tail section, which may taper to a trailing end of the package.

In such embodiments, the thermally insulated package suitably comprises an aerodynamic tail section and the main body tapers to the tail section and the nose section, which taper to a trailing edge and to a leading edge of the package, respectively.

In the thermally insulated package of this first aspect, the outer casing of the thermally insulated package suitably forms the nose section (as well as the main body section which houses the payload retention volume and the at least one layer of insulation). Therefore in some embodiments, the nose section is integrally formed with the outer casing.

Alternatively, the nose section may be formed separately to the outer casing (main body section) and then attached to the main body section to complete the thermally insulated package. In such embodiments, the removal of the nose section from the main body section may provide access to the payload retention volume (once some of the layer of insulation has also been removed).

In embodiments wherein the thermally insulated package comprises a tail section, the outer casing suitably forms the nose section, main body section and the tail section. Therefore in some embodiments, the nose section and the tail section are integrally formed with the outer casing.

Alternatively, the tail section may be formed separately to the outer casing (main body section) and then attached to the main body section to complete the thermally insulated package. In such embodiments, the removal of the tail section from the main body section may provide access to the payload retention volume (once some of the layer of insulation has also been removed).

The outer casing may be formed from a packaging blank, for example a cardboard packaging blank. The outer casing and the nose section may be formed from the same packaging blank. The outer casing and the tail section may be formed from the same packaging blank. Suitably the outer casing, the nose section and the tail section are formed from the same packaging blank, suitably a cardboard packaging blank. Therefore the outer casing (and therefore the main body section) is suitably integrally formed with the nose section and the tail section from a packaging blank. This may provide a convenient and low cost way of assembling a thermally insulated package of this first aspect, suitable for transportation by unmanned aerial vehicle.

A suitable packaging blank may be formed by fixing together different parts of such a packaging blank, for example by gluing. This may be done to provide a packaging blank for a relatively complex thermally insulated package of this first aspect, for example wherein the package comprises a tail section and/or wherein the main body of the package is aerodynamically shaped, as discussed above.

In some embodiments, the outer casing and the nose section, and the tail section when present, are formed from a rigid polymeric material, suitably a relatively lightweight rigid polymeric material. In such embodiments, the thermally insulated package may be re-usable as the rigid polymeric material may be sufficiently durable for repeat usage. This embodiment may be particularly suitable for situations when the recipient of the thermally insulated package has the means to collect, store and return the thermally insulated package for re-use. The rigid polymeric material may advantageously be a biodegradable polymeric material.

In some embodiments, the outer casing and the nose section, and the tail section when present, are formed from cardboard. In such embodiments, the thermally insulated package may be intended as a single use package, as the cardboard used to construct the package may be relatively cheap and easily disposable, suitably biodegradable. This embodiment may be particularly suitable for situations where the recipient of the thermally insulated package does not have the means to collect, store and return the thermally insulated package, for example a recipient in a remote and/or under developed location. Advantageously, such a biodegradable package could be disposed of without adversely effecting the local environment as a non-degradable packaging would, such as a non-biodegradable polymeric material.

Suitably the thermally insulated package is a single use thermally insulated package. Suitably such single use thermally insulated packages are substantially biodegradable, suitably completely biodegradable (once a temperature sensitive payload has been removed).

Suitably the at least one layer of insulation is biodegradable. The at least one layer of insulation may be provided by a biodegradable polymeric material, suitably an expanded biodegradable polymeric material (closed cell foam) or an open cell foamed biodegradable polymeric material. The at least one layer of insulation may be provided by a natural fibrous material, for example jute, hemp, wool or straw. Suitably the natural fibrous material is formed into panels (or pads) for use as the at least one layer of insulation.

The at least one layer of insulation is suitably provided by discrete, separate panels or pads of insulation material, for example six panels of biodegradable insulation material, which together can be arranged to abut each other to define a cuboid or cubic shape complementary to the shape of the payload retention volume and/or the shape of the main body section of the package. Alternatively the insulation panels may be provided by a pre-joined or pre-formed insulated vessel or base, for example having five sides, which define a five sides of a cuboid or cubic shape complementary to the shape of the payload retention volume, and a separate insulation panel to complete the cuboid or cube, for example for use as or in a lid.

Suitably the insulation panels are arranged to abut each other around the payload retention volume in order to minimise any gaps which may admit air through the insulation layer into the payload retention volume. However, the insulation layer may not be completely air tight.

The thermally insulated package comprises at least one layer of insulation surrounding the payload retention volume. Suitably the thermally insulated package comprises more than one layer of insulation surrounding the payload retention volume. Suitably the thermally insulated package comprises at least two layers of insulation surrounding the payload retention volume. Therefore the thermally insulated package may comprise a second layer of insulation which at least partially surrounds the payload retention volume and a first layer of insulation which surrounds the second layer of insulation and therefore surrounds the payload retention volume. Both the first and second layers of insulation are suitably inside the outer casing and outside the payload retention volume.

The first layer of insulation may be provided by insulation panels or pads as discussed above. The second layer of insulation may be provided by coolant vessels or phase-change material containing vessels. Therefore the thermally insulated package comprises a layer of insulation panels or pads and a layer of coolant vessels or phase-change material containing vessels. Suitably the coolant vessels or phase-change material containing vessels define a payload retention volume and are therefore the innermost layer of insulation in the thermally insulated package.

Suitable coolant vessels and phase-change material containing vessels, and phase-change materials contained within them, are known in the art.

Suitably the coolant vessels or phase-change material containing vessels are pre-conditioned to a low temperature (by actively cooling) to provide the payload retention volume with an initial desired low temperature. The layer of insulation panels or pads then insulates the coolant vessels or phase-change material containing vessels and the payload retention volume from ambient conditions to maintain said desired low temperature during transportation by said unmanned aerial vehicle.

The thermally insulated package may comprise a descent slowing device, for example a parachute. The descent slowing device suitably slows the thermally insulated package down when it has been released from said unmanned aerial vehicle above the ground, suitably to a speed which would not cause damage to the package or to temperature sensitive goods in the payload retention volume when the package reaches the ground.

The descent slowing device may be housed in a tail section of the thermally insulated package and be deployable from the tail section on release of the package from the unmanned aerial vehicle.

The thermally insulated package may comprise a recess for accommodating at least one functional device, the recess arranged between the at least one layer of insulation and the outer casing. The recess may be provided in the nose section, the main body section or in the tail section, when present.

Said functional device which the recess of the thermally insulated package is intended to accommodate is suitably an electronic device for providing a beneficial function to the thermally insulated package, for example for providing a monitoring function. Suitable types of functional device intended to be accommodated in the recess in use are temperature monitoring devices, location determination devices, physical condition or event monitoring devices and/or communication devices. The functional device may be or include any one of more of the following: a temperature sensor, a light sensor, a shock sensor, an orientation sensor, an acceleration sensor, a speed sensor and a pressure sensor. One or more of said functional devices may be accommodated in the recess of the thermally insulated package, in use.

Suitably said functional device is a device for recording and/or communicating an internal temperature of the thermally insulated package.

The thermally insulated package comprises a recess for accommodating at least one functional device, the recess arranged between the at least one layer of insulation and the outer casing. The recess is suitably a volume within the outer casing of the thermally insulated package which is adapted to retain said functional device during transport of the package. Therefore the recess is enclosed and covered by the outer surface of the outer casing of the thermally insulated package, at least when the package is closed. The recess is outside of the at least one layer of insulation and therefore outside of the payload retention volume. The recess is suitably outside of all layers of insulation present in the thermally insulated package and is therefore in a part of the thermally insulated package which is not insulated to any significant extent and is not intended to be “temperature controlled” by the layer or layers of insulation.

Providing such a dedicated volume within the thermally insulated package but outside of the insulation and the payload retention volume means that the functional device does not have to be placed in the payload retention volume. This means that the functional device does not take up space in the payload retention volume which could otherwise be used for temperature sensitive goods and means that the payload retention volume does not have to be opened in order to insert or remove the functional device, which would adversely affect any temperature sensitive goods in the payload retention volume by exposing them to ambient conditions. Locating the recess and therefore said functional device inside the outer casing means that said functional device may be protected from physical impacts and moisture, compared to an alternative arrangement wherein such a functional device is mounted on the exterior of a thermally insulated package.

Suitably the functional device is received within an adapter and the adapter is received within the recess. Suitably the adapter is configured (i.e. sized and shaped) to fit closely into the recess and therefore not move significantly within the recess during normal usage of the thermally insulated package. Suitably the adapter comprises a cavity configured to closely fit a certain functional device and therefore not allow movement of the functional device within the adapter in the recess during normal usage of the thermally insulated package. The adaptor may therefore be configured for a particular size and shape of functional device and recess. The adaptor is suitably formed from a compressible material, for example a foam, which can compress and deform to allow insertion of the functional device into the adaptor and to allow insertion of the adaptor into the recess. The compressible material can then expand outwards to form an interference fit with the recess and the functional device to retain the functional device in position. The adaptor may therefore protect the functional device from physical shocks during normal usage of the thermally insulated package.

The thermally insulated package may comprise a coupling for releasable attachment to said unmanned aerial vehicle. Said unmanned aerial vehicle may therefore be provided with a complimentary coupling which can engage with the coupling of the thermally insulated package. In some embodiments, the coupling of the thermally insulated package comprises a plate arranged inside a top face of the outer casing, suitably in a main body of the outer casing, and at least one aperture through the outer casing for accessing the plate. Suitably said coupling of the unmanned aerial vehicle comprises an arm which can reach through the aperture in the outer casing and engage with the plate. Alternatively the plate may comprise at least one protrusion through the aperture to which said coupling of said unmanned aerial vehicle can engage.

Suitably this arrangement of the plate in the outer casing allows the distribution across the outer casing of the force acting on the outer casing due to the weight of the package, when the thermally insulated package is attached to said unmanned aerial vehicle

According to a second aspect of the present invention, there is provided a packaging blank configured to form a packaging comprising an aerodynamic nose section and an outer casing comprising a payload retention volume.

The packaging formed by the packaging blank of this second aspect may be a thermally insulated packaging according to the first aspect and therefore may have any of the suitable features and advantages described in relation to the first aspect.

The packaging blank may be a one-piece packaging blank which, when folded and joined together, provides an outer casing for a thermally insulated package comprising a main body section, a nose section and optionally a tail section as described in relation to the first aspect.

In some embodiments, the packaging blank may be a two-piece packaging blank which, when folded and joined together, provides an outer casing for a thermally insulated package comprising a main body section, a nose section and optionally a tail section as described in relation to the first aspect. Suitably a first part of the two-piece packaging blank is configured to provide the main body section and optionally the tail section of the outer casing, and a second part of the two-piece packaging blank is configured to provide the nose section of the outer casing. Alternatively, a first part and a second part of the two-piece packaging blank may both be configured to provide a part or parts of the main body, the nose section and optionally the tail section of the outer casing, if present.

According to a third aspect of the present invention, there is provided an unmanned aerial vehicle for delivery of temperature sensitive goods, the unmanned aerial vehicle comprising a thermally insulated package according to the first aspect and a release mechanism for releasing the thermally insulated package from the unmanned aerial vehicle, wherein the nose section of the thermally insulated package is exposed to air resistance during forward movement of the unmanned aerial vehicle.

The thermally insulated packaging may have any of the suitable features and advantages described in relation to the first aspect.

In some embodiments, the present invention may provide a package as described herein which is not provided with insulation and is therefore suitable for transporting non-temperature sensitive goods. Therefore according to a further aspect of the present invention, there is provided a package for transportation by unmanned aerial vehicle, the package comprising:

a payload retention volume;

an outer casing enclosing the payload retention volume; and

an aerodynamic nose section arranged at the front of the thermally insulated package with respect to the direction of flight of said unmanned aerial vehicle.

The packaging of this further aspect may have any of the suitable features and advantages described in relation to the thermally insulated package of the first aspect.

### BRIEF DESCRIPTION OF THE DRAWINGS

For a better understanding of the invention, and to show how example embodiments may be carried into effect, reference will now be made to the accompanying drawings in which:

FIG. 1 is a perspective view of a thermally insulated package according to the first aspect of the present invention.

FIG. 2 is a cross-sectional view of the thermally insulated package of FIG. 1 along line X.

FIG. 3 is a plan view of a packaging blank according to the second aspect of the present invention.

FIG. 4 is a plan view of a two-part packaging blank according to the second aspect of the present invention.

FIG. 5 is a plan view of a two-part packaging blank according to the second aspect of the present invention.

### DETAILED DESCRIPTION OF THE EXAMPLE EMBODIMENTS

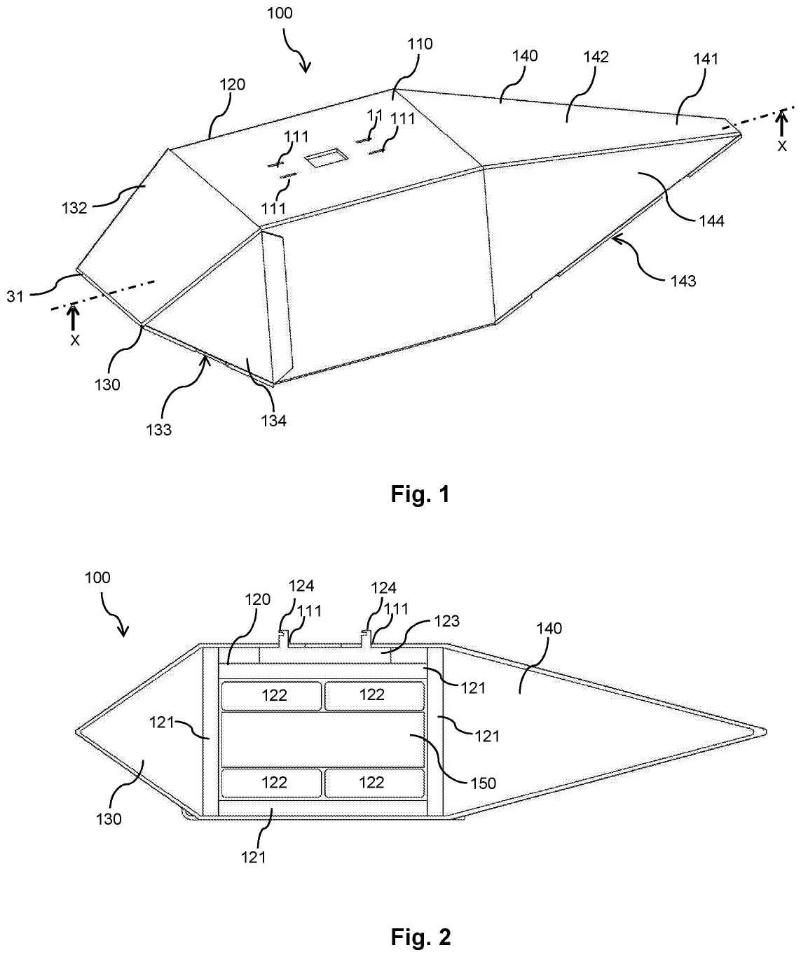

FIG. 1 shows a thermally insulated package 100 having external dimensions of from 20 to 200 cm in length and 10 to 50 cm in height and width, suitably approximately 65 cm in length and approximately 25 cm in height and width. FIG. 2 shows a cross sectional view through the vertical central plane (X) of the thermally insulated package 100. The thermally insulated package 100 is formed from a cardboard packaging blank and comprises an outer casing 110 which defines a main body section 120, a nose section 130 and a tail section 140. The main body section 120 encloses a layer of six insulation pads 121 arranged in a cuboid, four of which are visible in FIG. 2, a layer of four coolant containing vessels 122 and a payload retention volume 150. The main body section 120 is cuboid in shape.

Nose section 130 comprises leading edge 131, top face 132, bottom face 133 and two side faces 134. The top face 132, bottom face 133 and two side faces 134 taper from the main body section 120 to the leading edge 131, providing the nose section 130 with an aerodynamic shape. The nose section 130 is closed onto the main body section 120 using tabs and slots (not shown). The nose section 130 may also comprise adhesive to hold it closed onto the main body section 120 in use. The nose section 130 can be opened by undoing the tabs from the slots (and breaking any adhesive bond present) which allows the user access to the inside of the nose section 130 and the inside of the main body section 120, and therefore to access the payload retention volume once the insulation pads 121 have been removed. Alternatively, tear strips can be provided in the outer casing 110.

Tail section 140 comprises trailing edge 141, top face 142, bottom face 143 and two side faces 144. The top face 142, bottom face 143 and two side faces 144 taper from the main body section 120 to the trailing edge 141, providing the tail section 140 with an aerodynamic shape. The tail section 140 is closed onto the main body section 120 using tabs and slots (not shown). The tail section 140 may also comprise adhesive to hold it closed onto the main body section 120 in use. The tail section 140 can be opened by undoing the tabs from the slots (and breaking any adhesive bond present) which allows the user access to the inside of the tail section 140 and the inside of the main body section 120, and therefore access to the payload retention volume once the insulation pads 121 have been removed.

The cross sectional view of FIG. 2 shows the internal storage volume provided by the nose section 130 and the tail section 140, which may be used for storing a device, an accessory, a document or a descent slowing device, such as a parachute. FIG. 2 also shows the arrangement of insulation pads 121 within main body section 120 which abut each other to form a cuboidal internal space. This cuboidal internal space is occupied by the payload retention volume 150 and coolant vessels 122 which are arranged alongside and in contact with the payload retention volume, within the layer of insulation pads 121. The insulation pads are formed of hemp. The coolant vessels are formed of a polymeric material and are charged with water then frozen before use in order to cool the payload retention volume (and any temperature sensitive goods placed inside) during use.

FIG. 2 also shows plate 123 and protrusions 124 which are used to releasably attach the thermally insulated package to an unmanned aerial vehicle for transportation. Plate 123 is arranged underneath and in contact with the outer casing 110 so that the protrusions 124 of the plate 123 register with and pass through apertures 111 in the outer casing 110.

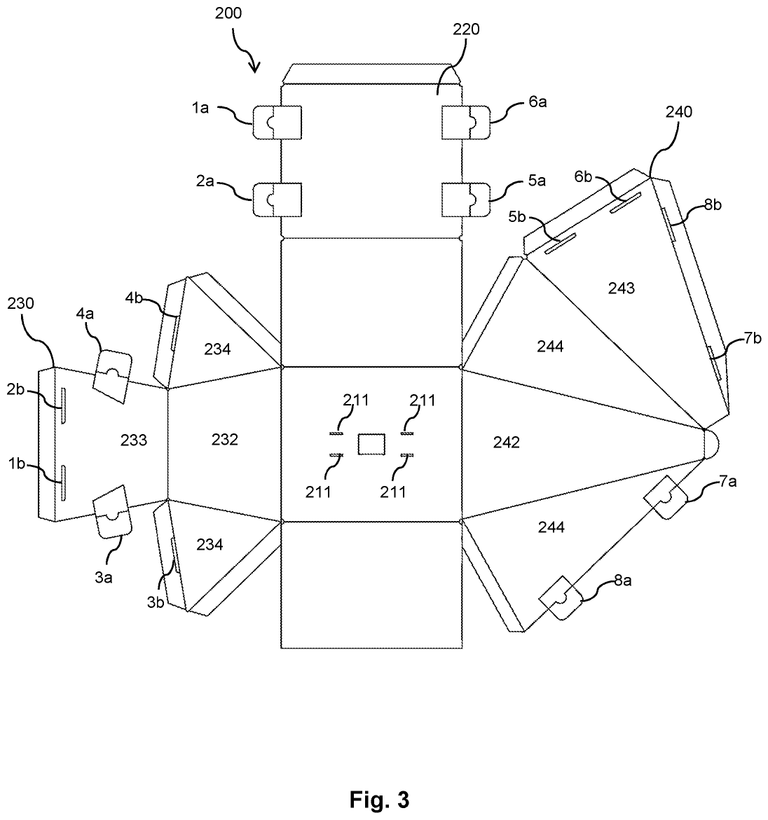

FIG. 3 shows packaging blank 200 formed from a suitable cardboard material and provided with fold lines shown (by the internal lines). FIG. 2 shows main body section region 220, nose section region 230 and tail section region 240 which will become the main body, nose and tail sections of the thermally insulated package produced from the blank 200, respectively. The nose section region 230 comprises top face 232, bottom face 233 and side faces 234. The top face 232 and the bottom face 233 are trapezoidal and joined by a fold line as shown. The side faces 234 are triangular. The top face 232, bottom face 233 and side faces 234 are configured with said shapes to fold up to form the aerodynamic shaped nose section described above having leading edge 131.

Tail section 240 comprises top face 242, bottom face 243 and side faces 244. The top face 242 and the bottom face 243 are trapezoidal and joined by a fold line as shown. The side faces 244 are triangular. The top face 242, bottom face 243 and side faces 244 are configured with said shapes to fold up to form the aerodynamic shaped tail section described above having trailing edge 141.

Main body section region 220 comprises apertures 211 for facilitating the releasable attachment of a thermally insulated package formed from the blank 200 to said unmanned aerial vehicle, as described above.

The packaging blank can be folded up according to the score lines shown and by inserting the numbered tabs labelled “a” into their respective slots labelled “b”, for example by inserting tab 1a into slot 1b, to provide the outer casing, nose section and tail section of the thermally insulated packaging 100 of FIGS. 1 and 2.

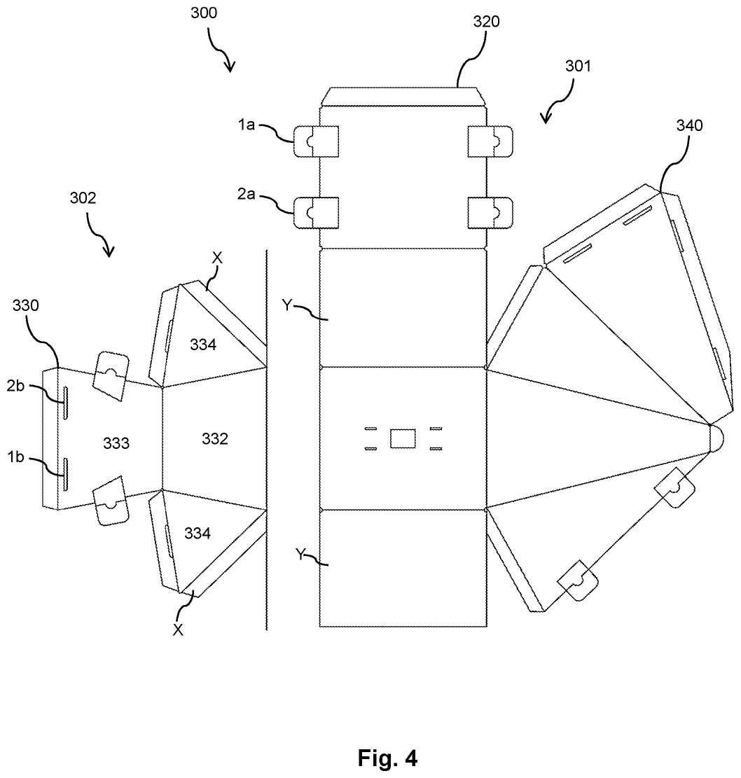

FIG. 4 shows a two-part packaging blank 300 comprising a first part 301 which provides a main body section region 320 and a tail section region 340, and a second part which provides a nose section region 330. The two-part packaging blank 300 can be folded and joined together as described in relation to blank 200, except that the second part 302 (nose section region 330) is joined to the first part 301 (at the main body section region 320) by inserting tabs 1a and 2a into slots 1b and 2b and by fixing flaps X to the main body section region 320 at positions Y, suitably with adhesive. The thermally insulated package so formed may be opened by releasing the flaps X from the main body section, to allow access to the payload retention volume.

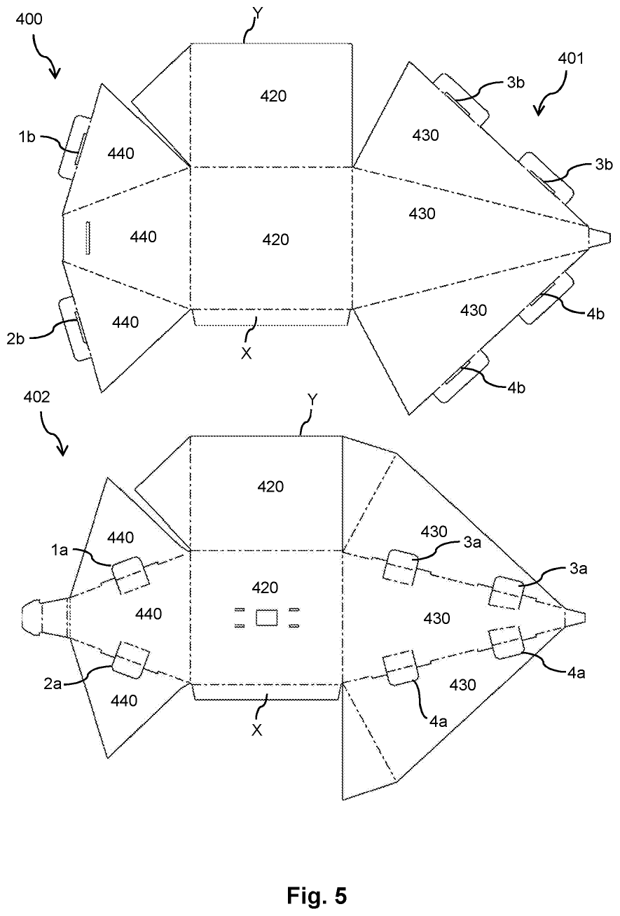

FIG. 5 shows a two-part packaging blank 400 comprising a first part 401 and a second part 402. The first part 401 and the second part 401 both provide main body section regions 420, nose section regions 430 and tail section regions 440, which come together on assembly of the packaging blank 400 to provide the main body, nose section and tail section of the outer casing of a thermally insulated package. The two-part packaging blank 400 can be folded and joined together in a similar manner to that described in relation to blank 300 by inserting tabs 1a, 2a, 3a and 4a into slots 1b, 2b, 3b and 4b and by fixing flaps X to the main body section region 420 at positions Y, suitably with adhesive. The thermally insulated package so formed may be opened by releasing the flaps X from the main body section, to allow access to the payload retention volume.

Blanks 200, 300 and 400 provide a convenient and cost effective means of forming an outer casing for a thermally insulated package which can allow a single use and biodegradable thermally insulated package, when suitable biodegradable insulation materials are chosen, which is particularly suited for delivery by unmanned aerial vehicle to remote and/or underdeveloped locations.

In summary, the present invention provides a thermally insulated package for transporting a temperature sensitive payload by unmanned aerial vehicle. The thermally insulated package comprises a payload retention volume, at least one layer of insulation surrounding the payload retention volume and an outer casing enclosing the at least one layer of insulation and the payload retention volume. The thermally insulated package is shaped to reduce drag in flight by having an aerodynamic shape, particularly in a nose section and optionally a tail section. The thermally insulated package may be particularly suitable as a single use packaging for transporting temperature sensitive goods to remote locations. A packaging blank and an unmanned aerial vehicle comprising the thermally insulated package is also provided.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other minor components unrelated to the technical effect of the invention.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A thermally insulated package for transportation by unmanned aerial vehicle, the thermally insulated package comprising:
a payload retention volume;
at least one layer of insulation surrounding the payload retention volume;
an outer casing enclosing the at least one layer of insulation and the payload retention volume; and
an aerodynamic nose section arranged at the front of the thermally insulated package with respect to the direction of flight of said unmanned aerial vehicle.

2. The thermally insulated package according to claim 1, wherein the nose section tapers to a leading edge at the front of the nose section.

3. The thermally insulated package according to claim 2, wherein the nose section comprises a top face, a bottom face and two side faces which meet at the leading edge and are arranged at acute angles to the direction of flight of said unmanned aerial vehicle; wherein at least one of said faces provides an access door to the payload retention volume.

4. The thermally insulated package according to claim 1 comprising an aerodynamic tail section arranged at the rear of the thermally insulated package with respect to the direction of flight of said unmanned aerial vehicle.

5. The thermally insulated package according to claim 4, wherein the outer casing forms the nose section and the tail section.

6. The thermally insulated package according to claim 1, wherein the outer casing is formed from a packaging blank.

7. The thermally insulated package according to claim 1, wherein the outer casing is formed from cardboard.

8. The thermally insulated package according to claim 1, wherein the at least one layer of insulation is biodegradable.

9. The thermally insulated package according to claim 1 which is a single use thermally insulated package.

10. The thermally insulated package according to claim 1 comprising a descent slowing device.

11. The thermally insulated package according to claim 1 comprising a recess for accommodating at least one functional device, the recess arranged between the at least one layer of insulation and the outer casing.

12. The thermally insulated package according to claim 1 comprising a main body which comprises the payload retention volume and the at least one layer of insulation, wherein the main body has an approximately cuboid shape.

13. The thermally insulated package according to claim 1, wherein the at least one layer of insulation surrounding the payload retention volume comprises a second layer of insulation which at least partially surrounds the payload retention volume and a first layer of insulation which surrounds the second layer of insulation and the payload retention volume.

14. A packaging blank configured to form a packaging comprising an aerodynamic nose section and an outer casing comprising a payload retention volume.

15. An unmanned aerial vehicle for delivery of temperature sensitive goods, the unmanned aerial vehicle comprising a thermally insulated package according to claim 1 and a release mechanism for releasing the thermally insulated package from the unmanned aerial vehicle, wherein the nose section of the thermally insulated package is exposed to air drag during forward movement of the unmanned aerial vehicle.
